(19) United States
(12) Patent Application Publication
(10) Pub. No.: US 2018/0129000 A1
(43) Pub. Date: May 10, 2018

(54) Connector

(71) Applicant: Tyco Electronics (Shanghai) Co. Ltd., Shanghai (CN)

(72) Inventors: Wenyu Liu, Shanghai (CN); Hongqiang Han, Shanghai (CN); Chenxi Wang, Shanghai (CN); Lizhou Li, Shanghai (CN); Youwei Pan, Shanghai (CN)

(73) Assignee: Tyco Electronics (Shanghai) Co. Ltd., Shanghai (CN)

(21) Appl. No.: 15/805,687

(22) Filed: Nov. 7, 2017

(30) Foreign Application Priority Data
Nov. 7, 2016 (CN) 201610974690.X

(51) Int. Cl. G02B 6/42

(52) U.S. Cl. CPC G02B 6/4262; G02B 6/4273; G02B 6/4277; G02B 6/4292

(57) ABSTRACT

A connector for receiving one or more plug modules comprises a housing and a partition wall disposed in the housing and dividing an inner space of the housing into an upper insertion port and a lower insertion port. A first rigid convex member protruding toward an inner space of the upper insertion port is formed on a top wall of the upper insertion port and a second rigid convex member protruding toward an inner space of the lower insertion port is formed on a bottom wall of the lower insertion port. The first rigid convex member physically contacts a first plug module inserted into the upper insertion port and the second rigid convex member physically contacts a second plug module inserted into the lower insertion port.

### CROSS-REFERENCE TO RELATED APPLICATION

This application claims the benefit of the filing date under 35 U.S.C. § 119(a)-(d) of Chinese Patent Application No. 201610974690.X, filed on Nov. 7, 2016.

### FIELD OF THE INVENTION

The present invention relates to an electrical connector and, more particularly, to an electrical connector having good heat dissipation.

### BACKGROUND

In a conventional connector for high-speed data transmission, due to an increased speed of data transmission and an application in which a high power optical module is received in the connector, heat dissipation for the connector is vital. However, in the prior art, a large gap is formed between the high power optical module and a housing of the connector when the high power optical module is inserted into an insertion port of the housing of the connector. The large gap is formed due to limitations of an electromagnetic shielding elastic sheet formed on an outside of the high power optical module and an inner positioning structure of the housing of the connector. The high power optical module does not physically contact the housing of the connector, which produces a large thermal resistance and reduces thermal performance of the connector.

In order to distribute the heat generated by the inserted high power optical module to the outside of the housing of the connector, an inwardly projecting resilient boss may be disposed on the housing of the connector. The resilient boss directly and physically contacts the inserted high power optical module. However, in order to ensure reliable physical contact with the inserted high power optical module, the resilient boss has a large amount of interference with the high power optical module. A large insertion force is required when the high power optical module is inserted into the housing, which may not be easily controlled by a user. Further, in order to form the resilient boss on the housing of the connector, it is necessary to form long slits in the housing of the connector, which weaken the electromagnetic shielding of the housing. Additionally, external water vapor or contaminants can easily enter into the housing of the connector through the slits.

### SUMMARY

A connector for receiving one or more plug modules according to the invention comprises a housing and a partition wall disposed in the housing and dividing an inner space of the housing into an upper insertion port and a lower insertion port. A first rigid convex member protruding toward an inner space of the upper insertion port is formed on a top wall of the upper insertion port and a second rigid convex member protruding toward an inner space of the lower insertion port is formed on a bottom wall of the lower insertion port. The first rigid convex member physically contacts a first plug module inserted into the upper insertion port and the second rigid convex member physically contacts a second plug module inserted into the lower insertion port.

### BRIEF DESCRIPTION OF THE DRAWINGS

The invention will now be described by way of example with reference to the accompanying Figures, of which:

FIG. 1 is a side perspective view of a connector according to the invention;

FIG. 2 is a front perspective view of the connector of FIG. 1;

FIG. 3 is a bottom perspective view of the connector of FIG. 1;

FIG. 4 is a sectional view of the connector of FIG. 1; and

FIG. 5 is a sectional view of the connector of FIG. 1 with a plug module inserted into an upper insertion port of the connector.

### DETAILED DESCRIPTION OF THE EMBODIMENT(S)

Embodiments of the present invention will be described hereinafter in detail with reference to the attached drawings, wherein like reference numerals refer to the like elements. The present invention may, however, be embodied in many different forms and should not be construed as being limited to the embodiments set forth herein; rather, these embodiments are provided so that the disclosure will be thorough and complete and will fully convey the concept of the invention to those skilled in the art.

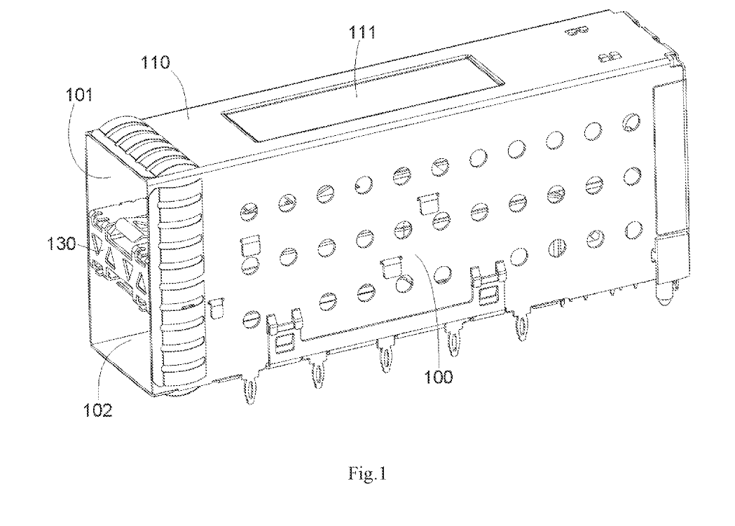

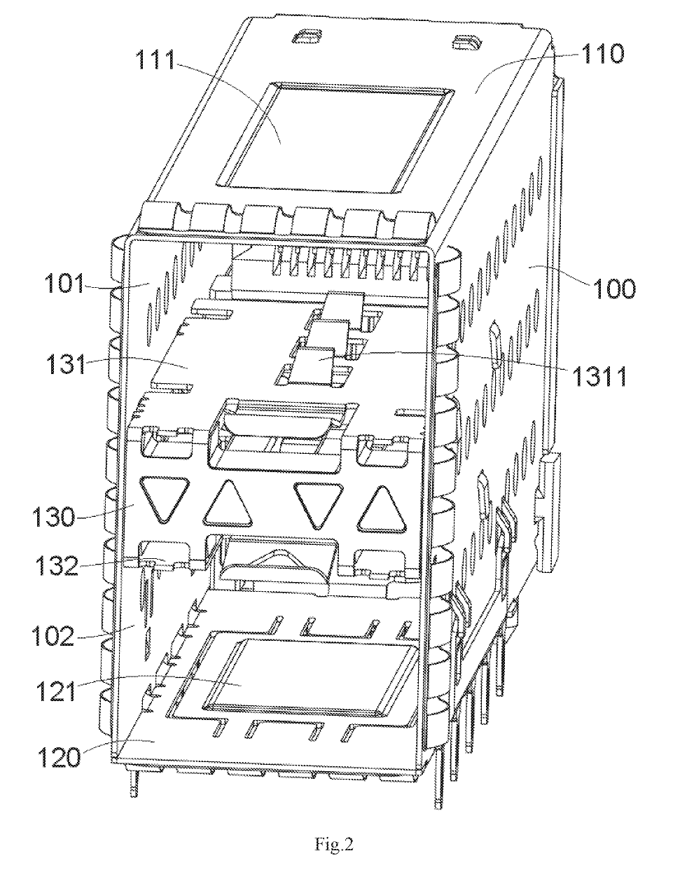

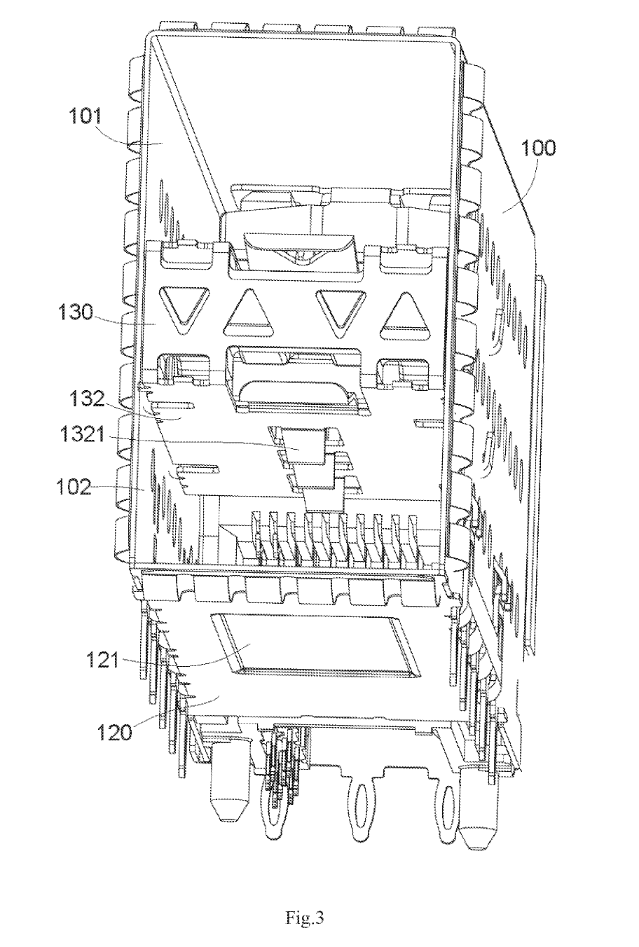

A connector according to the invention is shown in FIGS. 1-5. The connector comprises a housing 100 and a partition wall 130. The partition wall 130 is disposed in the housing 100 and divides an inner space of the housing 100 into an upper insertion port 101 and a lower insertion port 102.

As shown in FIGS. 1-3, a first rigid convex member 111 protruding toward an inner space of the upper insertion port 101 is formed on a top wall 110 of the upper insertion port 101. A second rigid convex member 121 protruding toward an inner space of the lower insertion port 102 is formed on a bottom wall 120 of the lower insertion port 102. In the shown embodiment, the first rigid convex member 111 is formed by punching the top wall 110 of the upper insertion port 101 and the second rigid convex member 121 is formed by punching the bottom wall 120 of the lower insertion port 102. In an embodiment, a height of the first rigid convex member 111 and the second rigid convex member 121 is 0.1 mm to 0.5 mm. In another embodiment, the height of the first rigid convex member 111 and the second rigid convex member 121 is 0.20 mm to 0.25 mm.

The partition wall 130, as shown in FIGS. 1-5, has an upper partition wall 131 and a lower partition wall 132, the lower partition wall 132 being located below the upper partition wall 131 and spaced apart from the upper partition wall 131 by a predetermined distance. The upper partition wall 131 constitutes a bottom wall of the upper insertion port 101 and the lower partition wall 132 constitutes a top wall of the lower insertion port 102.

As shown in FIGS. 1-5, at least one first elastic sheet 1311 protruding toward the inner space of the upper insertion port 101 is formed on the upper partition wall 131. At least one second elastic sheet 1321 protruding toward the inner space of the lower insertion port 102 is formed on the lower partition wall 132. In the shown embodiment, a plurality of first elastic sheets 1311 is formed on the upper partition wall 131, the plurality of first elastic sheets 1311 being arranged in at least one row in an insertion direction of a plug module 200 and being spaced apart from each other. In the shown embodiment, a plurality of second elastic sheets 1321 is formed on the lower partition wall 132, the plurality of second elastic sheets 1321 being arranged in at least one row in the insertion direction of the plug module 200 and being spaced apart from each other. In the shown embodiment, each first elastic sheet 1311 is formed by punching and bending the upper partition wall 131 and each second elastic sheet 1321 is formed by punching and bending the lower partition wall 132.

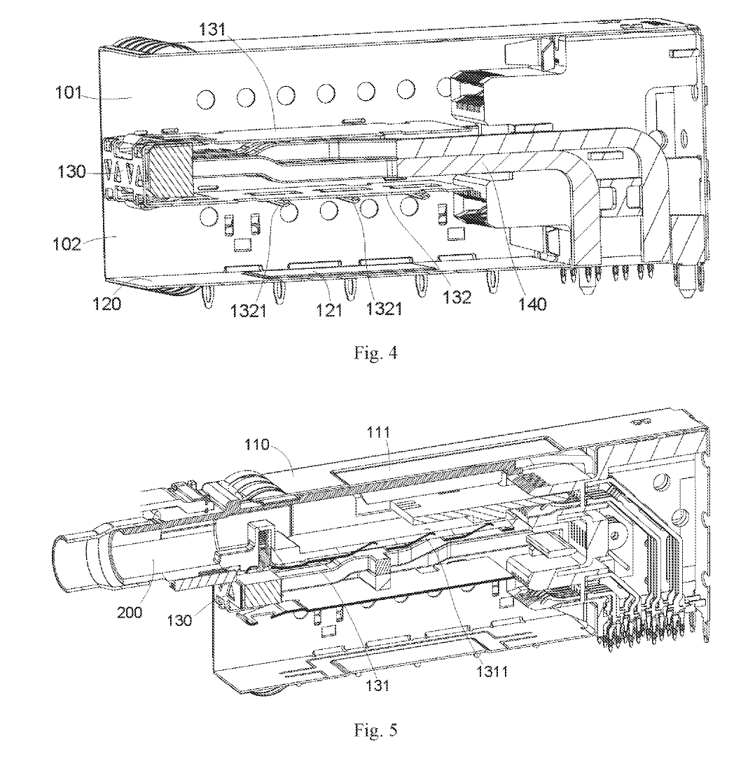

The connector, as shown in FIG. 4, further comprises at least one light pipe 140. The light pipe 140 is disposed in a receiving space between the upper partition wall 131 and the lower partition wall 132.

The connector, as shown in FIG. 5, receives one or more plug modules 200 in the upper insertion port 101 and the lower insertion port 102. In an embodiment, the one or more plug modules 200 may be high power optical modules.

As shown in FIG. 5, the first rigid convex member 111 physically contacts the plug module 200 inserted into the upper insertion port 101. The second rigid convex member 121 physically contacts a plug module 200 inserted into the lower insertion port 102. The first rigid convex member 111 and/or the second rigid convex member 121 is in surface contact with the inserted plug module 200. Each of the first rigid convex member 111 and the second rigid convex member 121 has a contact surface adapted to be in surface contact with the inserted plug module 200. In the shown embodiment, the contact surface has a rectangular shape. In other embodiments, the contact surfaces of the first rigid convex member 111 and the second rigid convex member 121 may also be formed in circular, oval or other suitable shapes known to those with ordinary skill in the art.

As shown in FIG. 5, the first elastic sheet 1311 presses the plug module 200 inserted into the upper insertion port 101 against the first rigid convex member 111 such that the plug module 200 is in physical contact with the first rigid convex member 111. Similarly, the second elastic sheet 1321 presses the plug module 200 inserted into the lower insertion port 102 against the second rigid convex member 121 such that the plug module 200 is in physical contact with the second rigid convex member 121.

Because the first rigid convex member 111 and the second rigid convex member 121 physically contact the plug module 200 in the upper and lower insertion ports 101, 102, a gap between the plug module 200 and the housing 100 is eliminated, improving heat dissipation of the connector through the first rigid convex member 111 and second rigid convex member 121 of the housing 100. Further, it is not necessary to form a slit in the housing 100, improving the electromagnetic shielding of the housing 100.

In other embodiments, the connector may have a single insertion port 101, 102. In a further embodiment, the insertion ports 101, 102 are arranged in a single layer and a rigid convex member 111, 121 protruding toward an inner space of each insertion port 101, 102 and adapted to physically contact the plug module 200 inserted into the insertion port 101, 102 is formed on a top wall 110 of the insertion port 101, 102.

What is claimed is:

1. A connector for receiving one or more plug modules, comprising:
a housing; and
a partition wall disposed in the housing and dividing an inner space of the housing into an upper insertion port and a lower insertion port, a first rigid convex member protruding toward an inner space of the upper insertion port is formed on a top wall of the upper insertion port and a second rigid convex member protruding toward an inner space of the lower insertion port is formed on a bottom wall of the lower insertion port, the first rigid convex member physically contacting a first plug module inserted into the upper insertion port and the second rigid convex member physically contacting a second plug module inserted into the lower insertion port.

2. The connector of claim 1, wherein the first rigid convex member is in surface contact with the first plug module or the second rigid convex member is in surface contact with the second plug module.

3. The connector of claim 1, wherein the partition wall has an upper partition wall and a lower partition wall disposed below the upper partition wall, the lower partition wall spaced apart from the upper partition wall by a predetermined distance.

4. The connector of claim 3, wherein the upper partition wall is a bottom wall of the upper insertion port and the lower partition wall is a top wall of the lower insertion port.

5. The connector of claim 4, wherein a first elastic sheet protruding toward the inner space of the upper insertion port is formed on the upper partition wall and/or a second elastic sheet protruding toward the inner space of the lower insertion port is formed on the lower partition wall.

6. The connector of claim 5, wherein the first elastic sheet is adapted to press the first plug module against the first rigid convex member and the second elastic sheet is adapted to press the second plug module against the second rigid convex member.

7. The connector of claim 5, wherein a plurality of first elastic sheets is formed on the upper partition wall and arranged in at least one row in an insertion direction of the first plug module and spaced apart from each other, and a plurality of second elastic sheets is formed on the lower partition wall and arranged in at least one row in an insertion direction of the second plug module and spaced apart from each other.

8. The connector of claim 1, wherein the first rigid convex member is integrally formed with a top wall of the upper insertion port and the second rigid convex member is integrally formed with a bottom wall of the lower insertion port, the first rigid convex member formed by punching the top wall of the upper insertion port and the second rigid convex member formed by punching the bottom wall of the lower insertion port.

9. The connector of claim 1, wherein the first rigid convex member has a first contact surface adapted to be in surface contact with the first plug module and the second rigid convex member has a second contact surface adapted to be in surface contact with the second plug module, the first contact surface and the second contact surface having a rectangular or circular shape.

10. The connector of claim 6, wherein the first elastic sheet is integrally formed with the upper partition wall and the second elastic sheet is integrally formed with the lower partition wall, the first elastic sheet formed by punching the upper partition wall and the second elastic sheet formed by punching the lower partition wall.

11. The connector of claim 3, further comprising at least one light pipe disposed in a receiving space between the upper partition wall and the lower partition wall.

12. The connector of claim 1, wherein a height of the first rigid convex member and the second rigid convex member is 0.1 mm to 0.5 mm.

13. The connector of claim 12, wherein a height of the first rigid convex member and the second rigid convex member is 0.20 mm to 0.25 mm.

14. A connector for receiving one or more plug modules, comprising:
a housing having at least one insertion port disposed in a single layer, a rigid convex member protruding toward an inner space of each insertion port is formed on a top wall of each insertion port and is adapted to physically contact a plug module inserted into the insertion port.

15. The connector of claim 14, wherein the rigid convex member is in surface contact with the plug module.

16. The connector of claim 14, wherein an elastic sheet protruding toward the inner space of the insertion port is formed on a bottom wall of the insertion port, the elastic sheet adapted to press the plug module against the rigid convex member.

17. The connector of claim 16, wherein a plurality of elastic sheets is formed on the bottom wall and arranged in at least one row in an insertion direction of the plug module and spaced apart from each other.

18. The connector of claim 14, wherein the rigid convex member has a contact surface adapted to be in surface contact with the plug module, the contact surface having a rectangular or circular shape.

19. The connector of claim 14, wherein a height of the rigid convex member is 0.1 mm to 0.5 mm.

20. The connector of claim 19, wherein a height of the rigid convex member is 0.20 mm to 0.25 mm.
